(19) United States
(12) Patent Application Publication
(10) Pub. No.: US 2026/0071375 A1
(43) Pub. Date: Mar. 12, 2026

(54) DAMPER FOR WASHING MACHINE COVER AND MANUFACTURING MOLD THEREFOR

(71) Applicant: Seyang Mechatronics Co.,Ltd., Siheung-si (KR)

(72) Inventor: Byung Jun KIM, Incheon (KR)

(21) Appl. No.: 19/031,439

(22) Filed: Jan. 18, 2025

(30) Foreign Application Priority Data
Sep. 10, 2024 (KR) 10-2024-0123073

(51) Int. Cl. D06F 39/14; B29C 45/26; B29L 31/00; E05F 5/02; E05F 7/04

(52) U.S. Cl. CPC D06F 39/14; B29C 45/261; E05F 5/02; E05F 7/04; B29C 2045/2683; B29L 2031/721; B29L 2031/762

(57) ABSTRACT

Disclosed is a damper for a washing machine cover, the damper including a cylindrical cylinder having a front end sealed by a side plate and a rear end fixed to a finishing cap, a rod configured to penetrate the finishing cap and partially inserted into the cylinder, a sealing member located between the piston and the finishing cap, a sealing member bracket supported by the rear end of the sealing member, a support spring configured to allow the sealing member bracket to be fixed at a predetermined position inside the cylinder, and an operating spring having one end supported by the side plate and the other end supported by the piston. The sealing member bracket (43) includes a sealing member fitting part (49) coupled to a seating groove of the sealing member, and a spring seating part (51) allowing an end (47a) of the support spring to be fitted thereinto.

### BACKGROUND OF THE INVENTION

### Field of the Invention

The present invention relates to a damper for a washing machine cover, and more particularly, to a damper for a washing machine cover, configured to perform a cushioning function so as to slowly close the washing machine cover, to remove frictional noise during operation, and to improve product quality so as to prevent damage to a cylinder, and a manufacturing mold for the damper.

### Description of the Related Art

Washing machines may be broadly classified into general washing machines and drum washing machines depending on the direction in which laundry is put into a washing tub. In the case of a general washing machine, laundry is put into a washing tub through the upper portion of the general washing machine. In the case of a drum washing machine, laundry is put into a washing tub through the front portion of the drum washing machine. Although drum washing machines have been widely distributed in recent years, the above-described drum washing machine and general washing machine respectively have positives and negatives in terms of structural configurations thereof. Accordingly, high-end general washing machines have been continuously released on the market.

The general washing machine has a cover provided at the upper portion thereof and configured to be opened and closed relative to a main body of the general washing machine. Here, a hinge is installed at a connection part between the cover and the main body of the general washing machine. The hinge includes a damper configured to slowly close the cover when the cover is closed. Normally, the damper is formed as a shock absorber. The shock absorber is formed of a cylinder filled with oil and a rod connected to the cylinder and configured to perform piston movement. When force is applied to the rod, the damper reduces the amount of impact caused by the force applied thereto. In other words, the damper absorbs force applied to the rod and allows the rod to operate slowly. Such dampers have been modified in various forms and used in various industries.

One of the problems caused by conventional dampers is oil leakage. When the rod is not exactly moved in the longitudinal direction of the cylinder, inappropriate movement of the rod may accelerate oil leakage.

In order to address the above-described problem, the applicant of the present invention disclosed Korean Patent No. 10-2227665 and was able to achieve satisfactory results. However, in this case as well, there is room for improvement due to the following problems.

First, a sealing member bracket 43 that is supported by the rear surface of a sealing member 7 and is assembled with the sealing member in a male-and-female coupling manner comes into contact with a support spring 47 during forward-and-rearward movement of the sealing member bracket, causing frictional noise.

Second, a cylinder 1 is formed of a cylindrical member and a side plate installed on one side of the cylindrical member. Here, the wall of the cylinder 1 often does not have a uniform thickness overall. In this case, cracks may be generated on the cylinder wall when pressure is continuously applied to the cylinder wall, leading to significant problems such as damage to a product and oil leakage.

### RELATED ART DOCUMENT

### Patent Document

(Patent Document 1) Korean Patent No. 10-2227665

### SUMMARY OF THE INVENTION

Therefore, the present invention has been made in view of the above problems, and it is an object of the present invention to provide a damper for a washing machine cover capable of preventing leakage of oil that fills the inside of a cylinder so as to perform a cushioning function of the damper.

It is another object of the present invention to provide a damper for a washing machine cover and a manufacturing mold therefor, configured to remove noise generated during operation and to provide a uniform wall thickness of a cylinder, thereby preventing cracks generated by long-term use.

In accordance with an aspect of the present invention, the above and other objects can be accomplished by the provision of a damper for a washing machine cover, the damper including a cylindrical cylinder having a front end sealed by a side plate and a rear end fixed to a finishing cap, a rod configured to penetrate the finishing cap and partially inserted into the cylinder, the rod having one end inserted into the cylinder and the other end located outside the cylinder, the one end having a piston installed thereon, and the other end having a receptor installed thereon, a ring-shaped sealing member located between the piston and the finishing cap, the sealing member being configured to prevent oil leakage inside the cylinder, a locking jaw provided on an inner wall of the cylinder, the locking jaw being configured to prevent the sealing member from moving toward the front end of the cylinder, a sealing member bracket supported by a rear end of the sealing member, a support spring configured to allow the sealing member bracket to be fixed at a predetermined position inside the cylinder, and the support spring having one end supported by the sealing member bracket and the other end supported by the finishing cap, and an operating spring having one end supported by the side plate and the other end supported by the piston, the operating spring being configured to elastically push a front end of the piston so as to apply elastic force to the rod such that the rod is withdrawn from the cylinder,

wherein the sealing member bracket (43) includes a sealing member fitting part (49) coupled to a seating groove formed in the sealing member in a male-and-female manner, and a spring seating part (51) installed on an opposite side of the sealing member fitting part, the spring seating part allowing an end (47a) of the support spring to be fitted thereinto, and the spring seating part (51) has a corner portion formed in a round shape.

A diameter of the corner portion of the spring seating part (51) may be 2 to 4 mm.

In accordance with another aspect of the present invention, there is provided a manufacturing mold for a cylinder of a damper for a washing machine cover,

wherein the manufacturing mold manufactures the cylinder through injection molding and includes an upper core plate provided for the injection molding of the cylinder, wherein the upper core plate has a plurality of resin injection ports provided therein and forms an outer surface of the side plate of the cylinder, and resin is injected into cavities through the respective resin injection ports.

The manufacturing mold may further include a cavity core coupled to a lower portion of the upper core plate, a lower core coupled to a lower portion of the cavity core, a striper plate coupled to an upper portion of the lower core, and a plurality of insert pins installed on the striper plate, the insert pins being respectively inserted into the cavities.

Three of the resin injection ports may be provided in a radially symmetrical arrangement.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a cross-sectional configuration diagram schematically showing the installation state of a damper for a washing machine cover according to an embodiment of the present invention;

FIG. 2 is a perspective view of the damper for a washing machine cover according to the embodiment of the present invention;

FIG. 3 is an exploded perspective view of the damper for a washing machine cover according to the embodiment of the present invention;

FIG. 4 is a cross-sectional view of the damper for a washing machine cover according to the embodiment of the present invention;

FIG. 5 is an exploded cross-sectional view of the damper for a washing machine cover according to the embodiment of the present invention;

FIG. 6 is a cross-sectional view of the use state of the damper for a washing machine cover according to the embodiment of the present invention;

FIG. 7 is a longitudinal cross-sectional configuration diagram of a manufacturing mold for a cylinder of the damper for a washing machine cover according to the embodiment of the present invention;

FIG. 8 is a planar configuration diagram of the manufacturing mold for the cylinder of the damper for a washing machine cover according to the embodiment of the present invention; and

FIG. 9 is a perspective view of the cylinder of the damper for a washing machine cover according to the embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

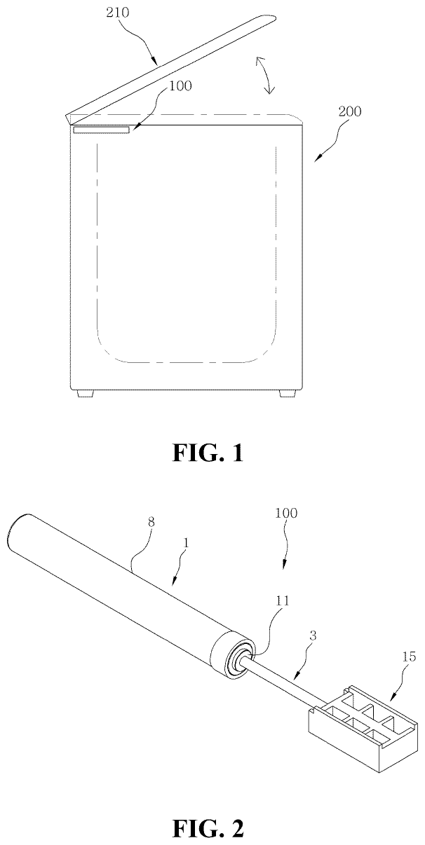

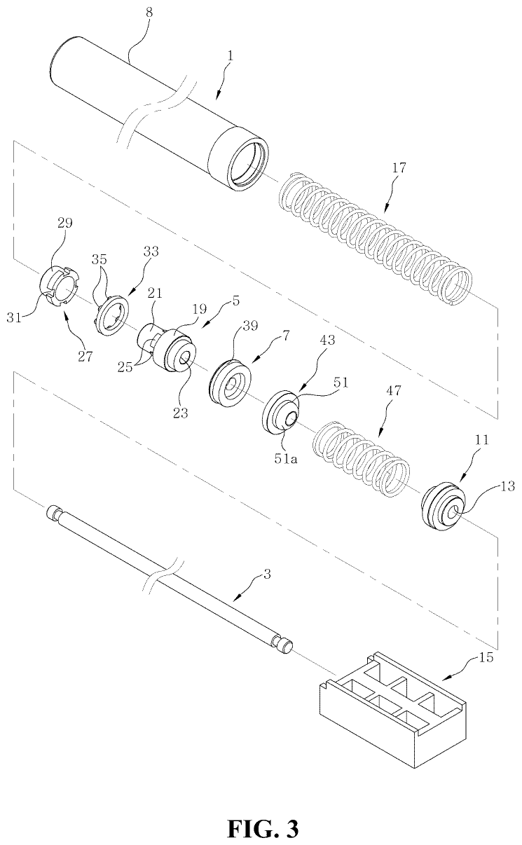

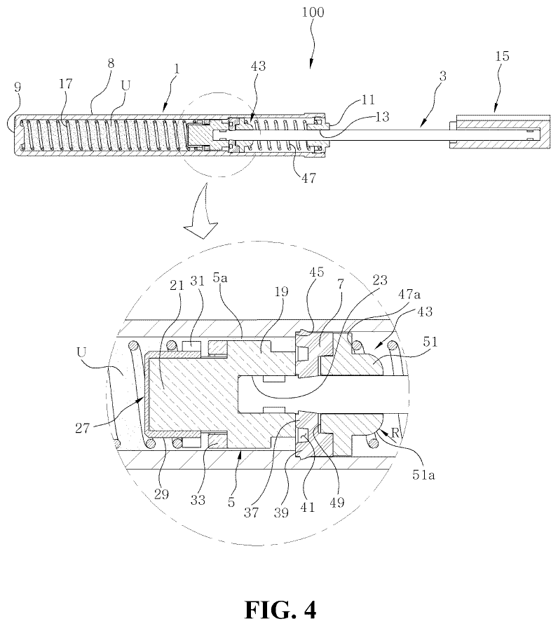

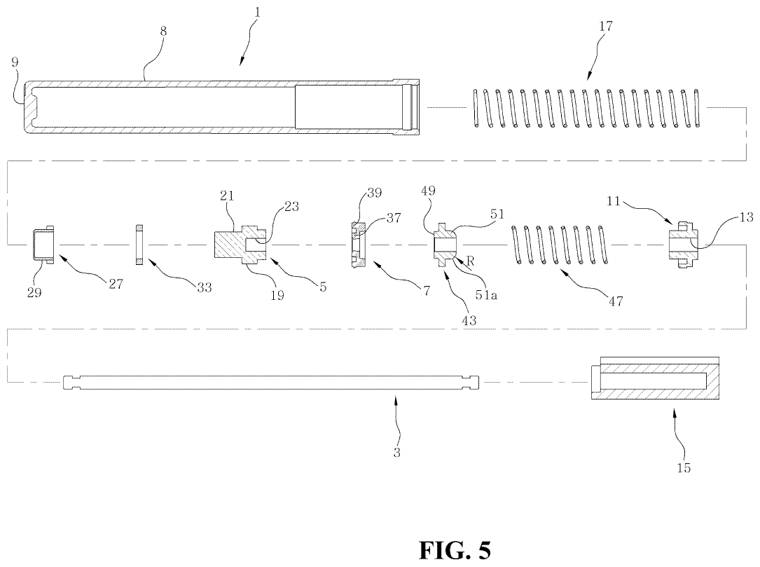

Hereinafter, embodiments of the present invention will be described in detail with reference to the accompanying drawings. First, the embodiments will be described with reference to FIGS. 1 to 5, and the remaining drawings will be referred to, as necessary.

A damper for a washing machine cover according to an embodiment of the present invention (100, hereinafter referred to as a “damper”) is installed for a cover 210 of a washing machine 200. The damper 100 is installed at a hinge portion of the washing machine 200 and the cover 210, that is, at the upper left and right sides of a washing machine body.

The damper 100 includes a cylinder 1, a rod 3, a piston 5, a sealing member 7, and a sealing member position fixing means. The cylinder 1 is formed of a long cylindrical wall 8 and a side plate 9 that is disposed at one end of the wall and is integrally installed with the wall 8 so as to seal the front end of the wall 8. The rear end of the cylinder 1 is sealed by a finishing cap 11 that is fixed to and assembled with the cylinder 1. The finishing cap 11 has a through hole 13 formed in the central portion thereof and configured for the rod 3 to pass therethrough.

The rod 3 is partially inserted into the cylinder 1 through the through hole 13 of the finishing cap 11. The piston 5 is connected to the front end of the rod 3 inserted into the cylinder 1, and a receptor 15 is connected to the rear end of the rod 3 located outside the cylinder 1. The lower end of the washing machine cover 210 transmits force to the rod 3 through the receptor 15. Normally, the dampers 100 are respectively installed on the left side of the cover 210 and the right side thereof.

The sealing member 7 is located between the piston 5 and the finishing cap 11. The sealing member 7 is installed in the middle position of the cylinder 1. The sealing member 7 is configured to prevent leakage of oil U inside the cylinder 1 and is formed to have a ring shape. The sealing member 7 is normally made of rubber (for example, NBR). The sealing member 7 is fixed to a fixed position inside the cylinder by the sealing member position fixing means.

An operating spring 17 is interposed between the side plate 9 and the piston 5. One end of the operating spring 17 is supported by the side plate 9, and the other end thereof is directly or indirectly supported by the piston 5. The operating spring 17 elastically pushes the front end of the piston 5 so as to apply elastic force to the rod 3, thereby causing the rod 3 to be withdrawn from the cylinder. The oil U is provided in the internal space of the cylinder 1 and fills a space between the side plate 9 and the sealing member 7.

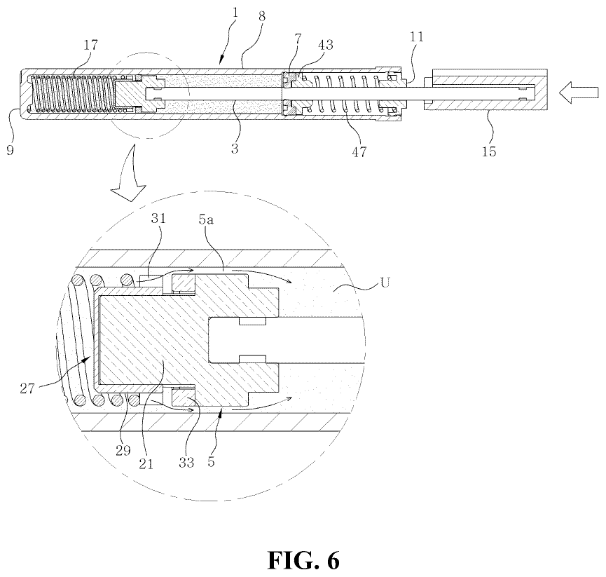

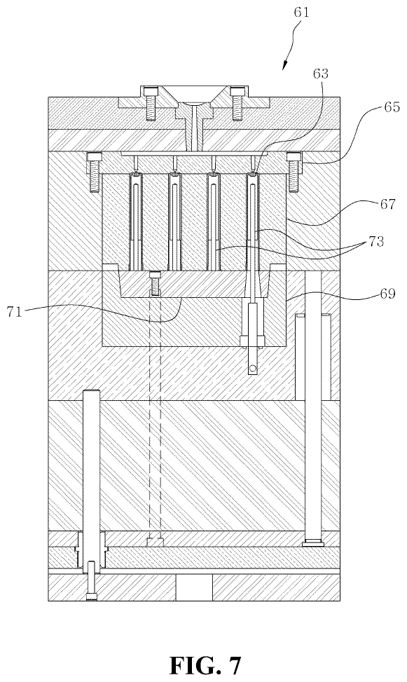

An oil distribution hole 5a may be provided between the piston 5 and the inner wall of the cylinder 1 or may be formed in the body of the piston 5. Here, the oil U may pass through the oil distribution hole 5a (refer to FIG. 6). The oil U encounters fluid resistance while passing through the oil distribution hole 5a, and this resistance performs a cushioning function of the damper.

The piston 5 is formed of a large diameter part 19 that comes into contact with the inner wall of the cylinder 1 and a small diameter part 21 formed to be integrated with the front end of the large diameter part 19. The end of the rod 3 is coupled to a rod coupling groove 23 provided in the rear end of the piston 5. Skirts 25 are formed to protrude from the small diameter part 21 and are arranged with an interval therebetween in the circumferential direction of the small diameter part.

Meanwhile, the operating spring 17 has a spring seat 27 installed at the rear end thereof and configured to support the end of the operating spring 17. The spring seat 27 is coupled to the piston 5 so as to be moved with the piston.

The spring seat 27 has a spring insertion part 29 inserted into the inside of the operating spring 17 and liquid flow holes 31 arranged with a regular interval therebetween in the circumferential direction of the spring seat.

According to another embodiment of the present invention, a piston ring 33 is interposed between the spring seat 27 and the piston 5. The piston ring 33 functions as a buffer and is configured to cushion or alleviate impact generated when the oil U passes through the piston 5. The piston ring 33 is fitted to the outer circumferential surface of the small diameter part 21 of the piston and the skirts 25 of the small diameter part. The piston ring 33 has protrusions 35 formed to protrude in a direction toward the operating spring 17 and arranged with an interval therebetween in the circumferential direction of the piston ring.

The sealing member 7 has a two-layer structure including an inner ring 37 in close contact with the outer circumferential surface of the rod 3 and an outer ring 39 in close contact with the inner wall of the cylinder 1. When oil is introduced into a space 41 defined between the inner ring 37 and the outer ring 39, the outer ring 39 and the inner ring 37 are configured to receive force in a direction in which the outer ring 39 and the inner ring 37 are further spaced apart from each other, thereby further enhancing a watertight function.

The sealing member bracket 43 is supported by the rear surface of the sealing member 7. The sealing member bracket 43 and the sealing member 7 that are fixed to each other by a bracket fixing means are assembled with each other in a male-and-female coupling manner.

The sealing member 7 is fixed to a middle point of the cylinder 1 by the sealing member position fixing means. The sealing member position fixing means may include a locking jaw 45 provided on the inner wall of the cylinder 1 and the bracket fixing means configured to fix the sealing member bracket 43 to a predetermined position inside the cylinder 1.

The locking jaw 45 is configured to prevent the sealing member 7 from moving toward the front end of the cylinder 1 and is a portion allowing the outer ring 39 of the sealing member 7 to be seated thereon.

The bracket fixing means may include the support spring 47 having one end supported by the sealing member bracket 43 and the other end supported by the finishing cap 11. The elastic modulus of the support spring 47 is higher than that of the operating spring 17, thereby preventing the support spring 47 from being pushed by the operating spring 17. The support spring 47 has a function of alleviating lateral force applied to the sealing member 7 located at the middle position of the cylinder.

According to the present invention, the sealing member is installed at the middle position of the cylinder 1. In addition, the rod 3 is supported by the piston 5, the sealing member bracket 43, and the finishing cap 13, respectively. That is, the rod 3 is supported at three points, thereby making it possible to perform linear movement of the rod 3.

According to the characteristics of the present invention, the sealing member bracket 43 includes a sealing member fitting part 49 coupled to a seating groove of the sealing member 7 in a male-and-female coupling manner, and a spring seating part 51 provided on the opposite side of the sealing member fitting part 49 and configured for the end 47a of the support spring to be fitted thereinto.

In the related art, noise and friction often occur during a process in which the support spring 47 is compressed by a corner portion of the spring seating part 51. However, according to the present invention, a corner portion 51a of the spring seating part 51 is formed to have a round shape. That is, since the edge is removed from the spring seating part 51, the spring seating part does not come into contact with the support spring 47. The diameter R of the corner portion 51a may be 2 to 4 mm. According to this structural configuration, even if the support spring 47 is compressed, the support spring does not come into contact with the spring seating part 51.

Hereinafter, a manufacturing mold according to another embodiment of the present invention will be described. Particularly, a description will be given as to a mold configured to manufacture a cylinder through injection molding. The mold to be described below is independent of the spring seating part 51 described above.

The cylinder 1 is made of synthetic resin and is manufactured by injection molding. Therefore, it is required to provide an injection mold capable of manufacturing the cylinder 1. As mentioned above, the cylinder 1 is formed to have a cylindrical shape in which one side of the cylinder is closed by the side plate 9 and the other side thereof is open. The outer diameter DO of the cylinder 1 may be 11 to 12 mm, and the inner diameter DI thereof may be 9 to 10 mm. In this case, the thickness T of the cylinder wall is theoretically 0.5 to 1.5 mm. The length L of the cylinder is 85 to 95 mm. Since the cylinder 1 having such a small size is manufactured by injection molding, the thickness T of the cylinder 1 may not be uniformly formed. In order to address the above-described problem, the present invention improves the structural configurations of the injection mold through various studies and repeated testing.

A cylinder manufacturing mold 61 according to the present invention is formed of an upper core plate 65 having a resin injection port 63 formed therein, a cavity core 67 coupled to a lower portion of the upper core plate 65, a lower core 69 coupled to a lower portion of the cavity core 67, and a stripper plate 71 mounted on an upper portion of the lower core 69. The striper plate 71 has a plurality of insert pins 73 installed on an upper portion thereof and configured to be inserted into respective cavities so as to form the internal space of the cylinder 1.

Since the size of the cylinder 1 is small, it is efficient to simultaneously produce a plurality of cylinders in one operation procedure. Here, eight cavities are prepared in one mold.

The upper core plate 65 is a portion that forms the outer surface of the side plate 9 of the cylinder 1. According to the present invention, a plurality of terminal resin injection ports 63 provided on the lower surface of the upper core plate 65 is provided for each cavity. That is, the injection mold has the resin injection ports 63 provided therein. Here, resin is injected into the cavity inside the mold through each of the resin injection ports. According to the present invention, a plurality of resin injection ports is provided in a molding portion of the side plate 9 of the cylinder.

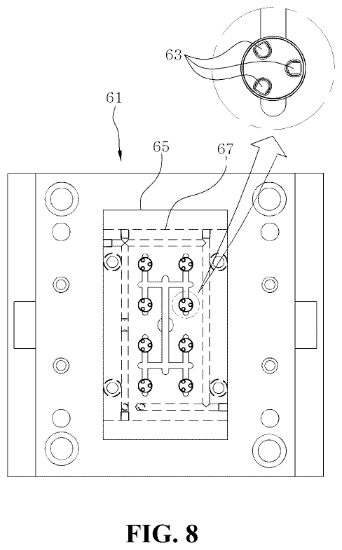

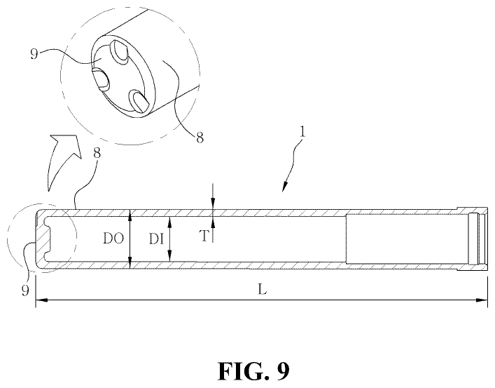

According to the present embodiment, as shown in FIG. 8, three resin injection ports 63 are provided in a radially symmetrical arrangement. The resin injection ports 63 are arranged with a regular interval therebetween along the edge of the side plate 9 of the cylinder. Through three resin injection ports 63, resin is injected into the cavity in a state of being evenly distributed, thereby enabling rapid injection of the resin. Furthermore, it is possible to eliminate a thickness difference of the cylinder wall 10. According to this method, the side plate 9 of the cylinder has a uniform shape and size overall, as shown in FIG. 9. However, in some cases, two resin injection ports 63 may be provided symmetrically.

As is apparent from the above description, the present invention provides the following effects.

According to the above-described structural configuration, since a sealing member configured to directly prevent oil leakage is installed in a middle portion of a cylinder, the sealing member is less affected by an external environment, thereby having an effect of reliably performing a function of the sealing member. As a result, it is possible to provide a damper for a washing machine cover capable of improving durability of the sealing member.

According to another feature of the present invention, straightness of a rod is increased so as to reduce eccentric load applied to a sealing member, thereby having an effect of providing a damper for a washing machine cover capable of extending the lifespan of the sealing member.

According to still another feature of the present invention, since a sealing member performs a sealing function in a state of being somewhat movable through a support spring, the operation of a damper is performed smoothly, and large force is not applied to the sealing member.

Although the present disclosure has been described in detail with reference to preferred embodiments thereof, the scope of the present disclosure is not limited to the above-described embodiments and the accompanying drawings, and it will be appreciated by those skilled in the art that various modifications and improvements may be made in the embodiments without departing from the principles and spirit of the disclosure, the scope of which is defined in the appended claims and equivalents thereto.

What is claimed is:

1. A damper for a washing machine cover, the damper comprising:
a cylindrical cylinder having a front end sealed by a side plate and a rear end fixed to a finishing cap;
a rod configured to penetrate the finishing cap and partially inserted into the cylinder, the rod having one end inserted into the cylinder and the other end located outside the cylinder, the one end having a piston installed thereon, and the other end having a receptor installed thereon;
a ring-shaped sealing member located between the piston and the finishing cap, the sealing member being configured to prevent oil leakage inside the cylinder;
a locking jaw provided on an inner wall of the cylinder, the locking jaw being configured to prevent the sealing member from moving toward the front end of the cylinder;
a sealing member bracket (43) supported by a rear end of the sealing member;
a support spring configured to allow the sealing member bracket (43) to be fixed at a predetermined position inside the cylinder, and the support spring having one end supported by the sealing member bracket (43) and the other end supported by the finishing cap; and
an operating spring 17 having one end supported by the side plate and the other end supported by the piston, the operating spring being configured to elastically push a front end of the piston so as to apply elastic force to the rod such that the rod is withdrawn from the cylinder,
wherein the sealing member bracket (43) comprises:
a sealing member fitting part (49) coupled to a seating groove formed in the sealing member in a male-and-female manner; and
a spring seating part (51) installed on an opposite side of the sealing member fitting part, the spring seating part allowing an end (47a) of the support spring to be fitted thereinto, and
wherein the spring seating part (51) has a corner portion (51a) formed in a round shape.

2. The damper according to claim 1, wherein a diameter (R) of the corner portion (51a) of the spring seating part (51) is 2 to 4 mm.

3. A manufacturing mold for a cylinder of a damper for a washing machine cover, the manufacturing mold being configured to manufacture the cylinder through injection molding, the damper comprising:
the cylindrical cylinder having a front end sealed by a side plate and a rear end fixed to a finishing cap;
a rod configured to penetrate the finishing cap and partially inserted into the cylinder, the rod having one end inserted into the cylinder and the other end located outside the cylinder, the one end having a piston installed thereon, and the other end having a receptor installed thereon;
a ring-shaped sealing member located between the piston and the finishing cap, the sealing member being configured to prevent oil leakage inside the cylinder;
a locking jaw provided on an inner wall of the cylinder, the locking jaw being configured to prevent the sealing member from moving toward the front end of the cylinder;
a sealing member bracket (43) supported by a rear end of the sealing member;
a support spring configured to allow the sealing member bracket (43) to be fixed at a predetermined position inside the cylinder, and the support spring having one end supported by the sealing member bracket (43) and the other end supported by the finishing cap; and
an operating spring having one end supported by the side plate and the other end supported by the piston, the operating spring being configured to elastically push a front end of the piston so as to apply elastic force to the rod such that the rod is withdrawn from the cylinder,
wherein the manufacturing mold comprises an upper core plate provided for the injection molding of the cylinder, wherein the upper core plate has a plurality of resin injection ports provided therein and forms an outer surface of the side plate of the cylinder, and
wherein resin is injected into cavities through the respective resin injection ports.

4. The manufacturing mold according to claim 3, further comprising:
a cavity core coupled to a lower portion of the upper core plate;
a lower core coupled to a lower portion of the cavity core;
a striper plate coupled to an upper portion of the lower core; and
a plurality of insert pins 73 installed on the striper plate, the insert pins being respectively inserted into the cavities.

5. The manufacturing mold according to claim 3, wherein three of the resin injection ports are provided in a radially symmetrical arrangement.
